(19) United States
(12) Patent Application Publication
(10) Pub. No.: US 2006/0082877 A1
(43) Pub. Date: Apr. 20, 2006

(54) Lenticular image display, its components and uses thereof

(76) Inventor: Xiong Zhun Wang, Zeng Cheng (CN)

Correspondence Address: Law Offices of Albert Wai-Kit Chan, LLC;World Plaza, Suite 604, 141-07 20th Avenue, Whitestone, NY, 11357, US

(21) Appl. No.: 11/109,261

(22) Filed: Apr. 18, 2005

(30) Foreign Application Priority Data
Oct. 15, 2004 (CN) 200420013917.7

(51) Int. Cl. G03B 21/60

(52) U.S. Cl. 359/455

(57) ABSTRACT

An improved lenticular image display is disclosed. The lenticular image display comprises a lenticular lens sheet, an image actuating assembly and an image fine-tuning assembly. The lenticular lens sheet comprises either a linear array of (i) plano-convex or (ii) trapezoid-convex cylindrical lenses. The image actuating assembly comprises either (i) a rotor-shaft, (ii) a sliding bar or (iii) reel spindle for effecting the changeover of the lenticular image. The lenticular image display further comprises a close-contact net for maintaining the lenticular image in intimate contact with the lenticular lens sheet to produce clear and sharp image changeovers. Clear and precise lenticular image changing effect ensures that the display is capable of serving as a stationary, rotational or multi-directional advertising medium, which takes full advantage of multiple image scrolling so as to increase advertising volume and expands its scope of application.

This application claims priority of Chinese patent application No. 200420013917.7, filed Oct. 15, 2004. The contents of this application are hereby incorporated in their entireties by reference into this application.

Throughout this application, various publications are referenced. Disclosures of these publications in their entireties are hereby incorporated by reference into this application in order to more fully describe the state of the art to which this invention pertains.

### FIELD OF THE INVENTION

The present invention generally relates to a self-actuating lenticular image display that is simpler and more economical to manufacture, assemble and maintain. The lenticular image display of the present invention also provides a mechanism for fine-tuning the alignment lenticular image for bringing the lenticular image into sharp and clear focus.

### BACKGROUND OF THE INVENTION

Advertising displays that employ a lenticular lens sheet consisting of a linear array of plano-convex cylindrical lenses, known individually as “lenticules”, to display optical effects or separate images are popular in the market.

Chinese Pat. No. 00266522.0, entitled “A Type of Dynamic-Refraction Changeable Lenticular Image Frame” (translated) discloses an apparatus having a housing for mounting a lenticular lens sheet. A clock movement is mounted inside the housing, and an eccenter mounted on the shaft of the clock movement. The lenticular lens sheet and the upper part of the housing form a chute for mounting the lenticular image. The lenticular images that can be viewed using this apparatus are made up of 2 to 5 interlaced images. The lenticular image is inserted into the picture chute such that the lenticular image faces the lenticular lens sheet.

Chinese Pat. No. 01208862.5, entitled “Clock with Self-Actuating, Adjustable Lenticular Lens Sheet” (translated), discloses an apparatus having a lenticular lens sheet mounted on the upper part of a display housing. The outside of lenticular lens sheet is flat. The inner surface of the lenticular lens sheet consists of a linear array of convex cylindrical lenses. A chute for holding the lenticular image is mounted in parallel with the lenticular lens sheet, and the chute has an opening for inserting the lenticular image. A lenticular image with 2 to 15 interlaced images may be inserted into the chute via the chute opening.

Existing lenticular image displays, such as the above-mentioned apparatus, have numerous drawbacks. Specifically, the lenticular image is inserted into a fixed image-holding chute, which results in the formation of “soft spots” because the lenticular image cannot maintain intimate contact with the backside of the lenticular lens sheet, and because the lenticular image resides outside the focal length of the lenticular lens sheet or lenticules. See U.S. Pat. No. 6,384,980. Additionally, the existing lenticular image displays do not provide a simple- and easy-to-operate image fine-tuning mechanism for optimizing the clarity of the displayed image.

U.S. Pat. No. 5,757,545, issued to Wu et al., discloses a lenticular image display and the structure of a lenticular lens. The lenticular image is mounted at a distance from the backside of the lenticular lens sheet on the focal plane of the lenticules. '545 patent does not provide a mechanism for adjusting or fine-tuning the alignment of the lenticular image to reduce “soft spots.” Furthermore, to allow a stationary viewer to perceive the different images presented in a lenticular image display as described in '545 patent, the lenticular display must be moved in order to achieve the necessary angle change. See U.S. Pat. No. 5,757,545.

Lenticular images that are typically used in conjunction with the lenticular lenses are composite image composed of several different independent images interlaced into the space. See U.S. Pat. App. Pub. No. US2004/0139635.

U.S. Pat. Nos. 6,384,980 and 6,624,947 issued to McKinley disclose the use of inflatable sealed bladder, vacuum, electro-conducting surfaces, fan, and/or pressure to maintain intimacy of relationship of the lenticular lens sheet with the lenticular image. The use of additional mechanical and electrical components makes these types of lenticular image displays more costly to manufacture, maintain and transport.

Therefore, there exists a need for a lenticular image display which displays a series of sharp and clear images, usually two or more, to the viewer sequentially. The lenticular image display of the present invention is more efficient to operate, more reliable, and more cost-effective to manufacture and maintain than any other previous lenticular image displays; allows for rapid fine-tuning of the lenticular image without the use of complicated electrical and/or mechanical components; and provides for easy access and fast changing of the lenticular image.

### SUMMARY OF THE INVENTION

This invention provides a self-actuating lenticular image display, comprising: a lenticular lens sheet attached to the front side of a display housing; a lenticular image; a close-contact net securely mounted behind the lenticular image to maintain the lenticular image and the lenticular lens sheet in intimate contact; and an image actuating assembly mounted inside the display housing for moving the lenticular image.

This invention provides a method for eliminating or minimizing soft spots or ghosting effect on the display of claim 1, comprising: (a) providing at an image fine-tuning assembly, wherein the image fine-tuning assembly comprises a gear; a positioning nose spike; and a drawing thread; (b) providing a close-contact net for maintaining the lenticular image in intimate contact with the back side of a lenticular screen; (c) mounting the close-contact net securely behind the lenticular image; (d) mounting the image fine-tuning assembly on the image actuating assembly; and (e) adjusting the gear on the image fine-tuning assembly to adjust the length of the drawing thread to align the horizontally interlaced images of the lenticular image in parallel with the lenticular lens.

### BRIEF DESCRIPTION OF THE FIGURES

FIG. 1A is a side elevation view of a lenticular lens sheet 1 of the present invention. The lenticular lens sheet 1 comprises a linear array of trapezoidal cylindrical lenses 3 on one side and a linear array of corresponding convex cylindrical lenses 2 on the other side.

The number of lenticules within a lenticular lens sheet is dependent on the size of the display and lenticular lens sheet. For example, if a display measures 30 inches wide and 40 inches high, and uses a lenticular lens sheet that has 20 lenticules per inch, then the lenticular lens sheet of the display will have 80 lenticules, i.e., 40 inches multiply by 20 lenticules per inch. The number of lenticules per inch is commonly referred to as the “resolution” of the lenticular lens sheet. Typically, lenticular lens sheets with 10-25 lenticules per inch are used. A lenticular lens sheet that has more lenticules per inch has a higher resolution. Generally, smaller lenticular image displays require higher resolution lenticular lens sheet to produce the desired effect.

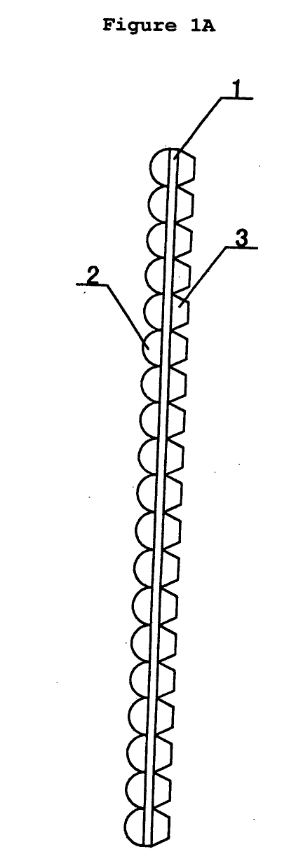

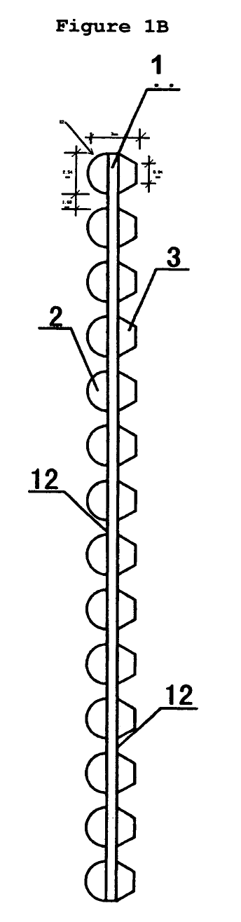

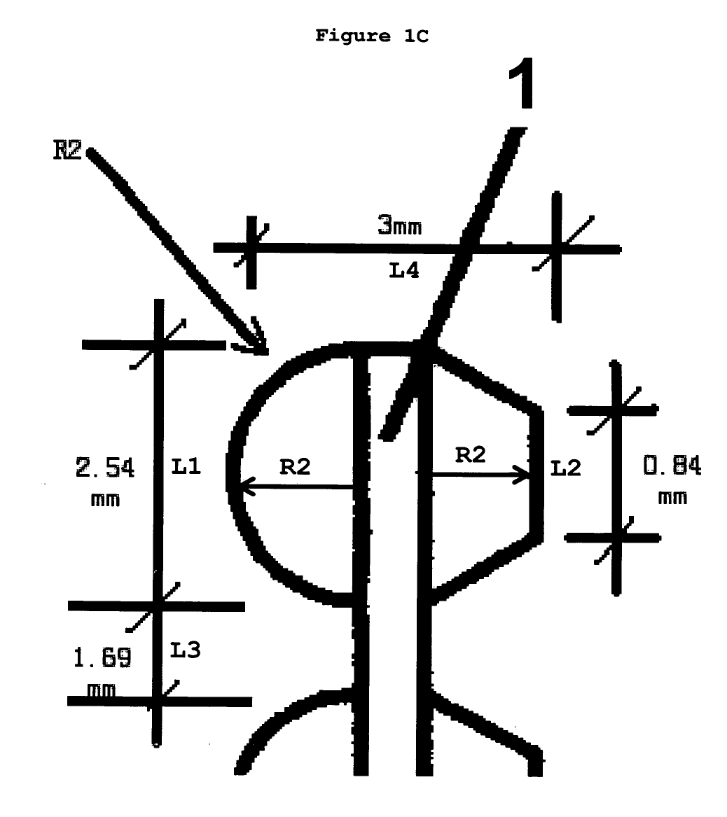

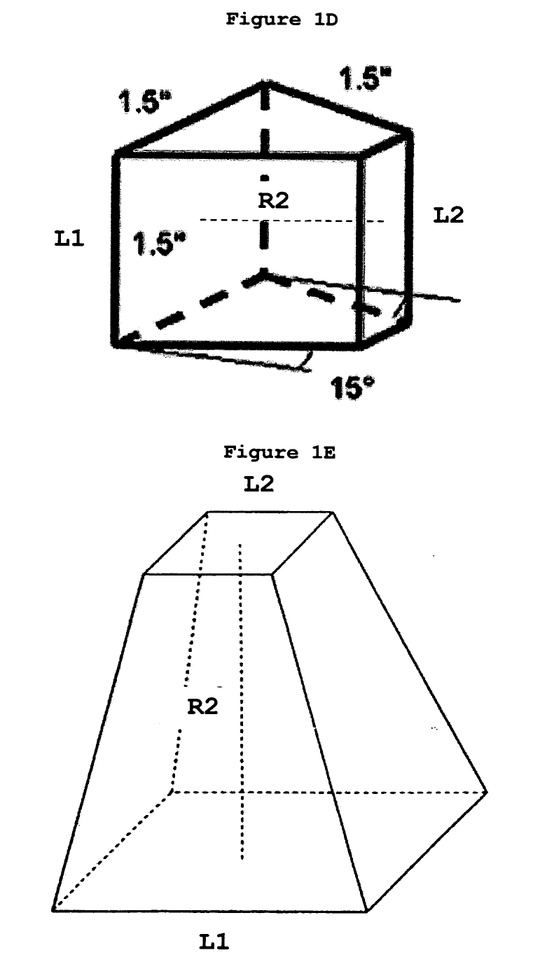

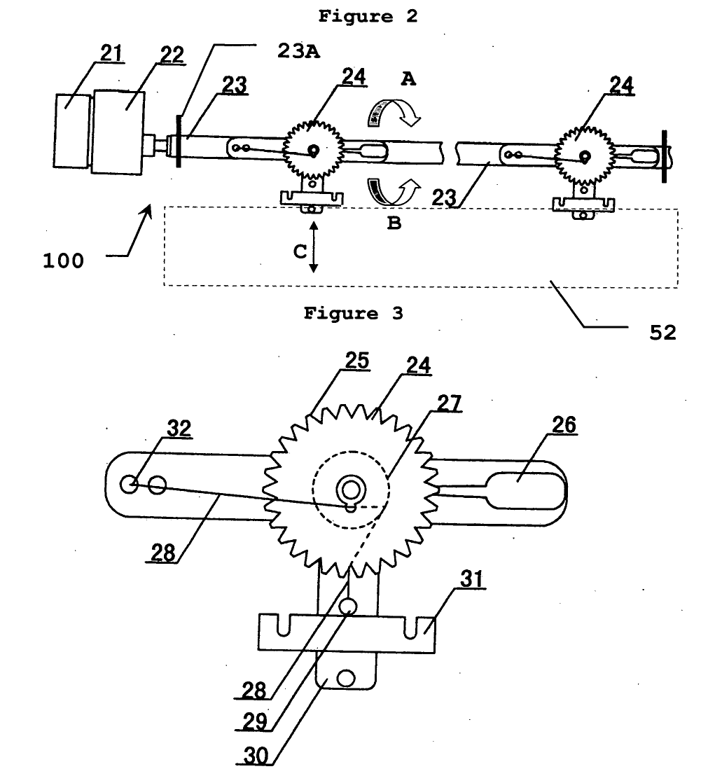

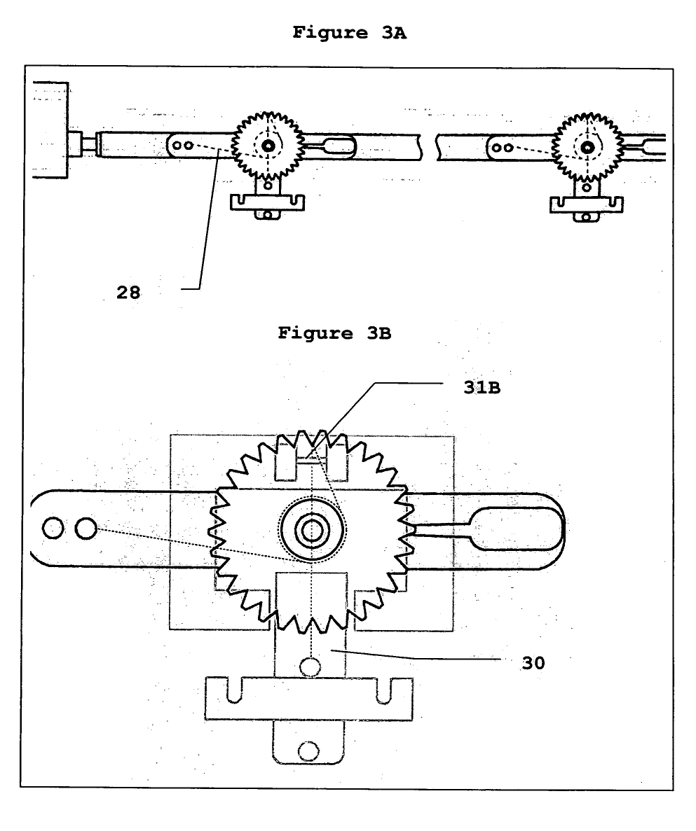

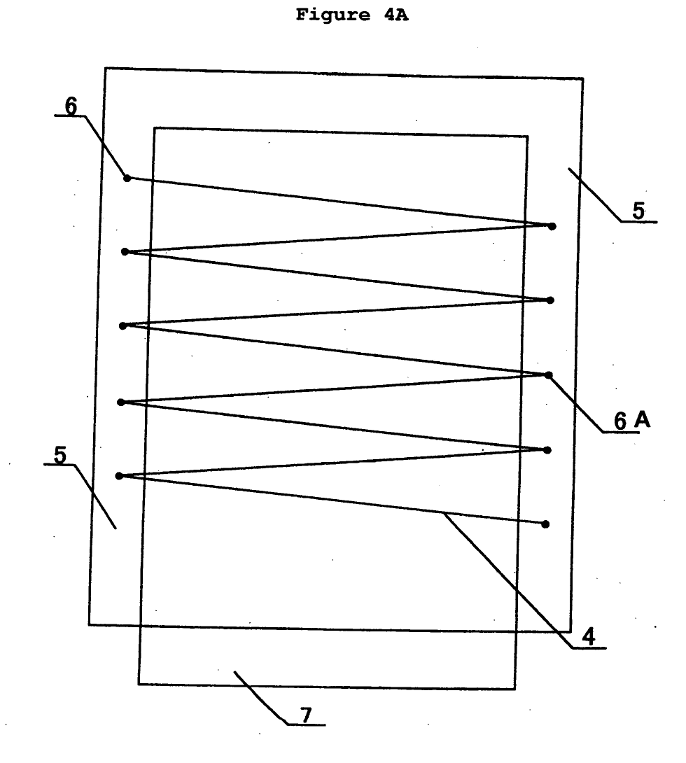

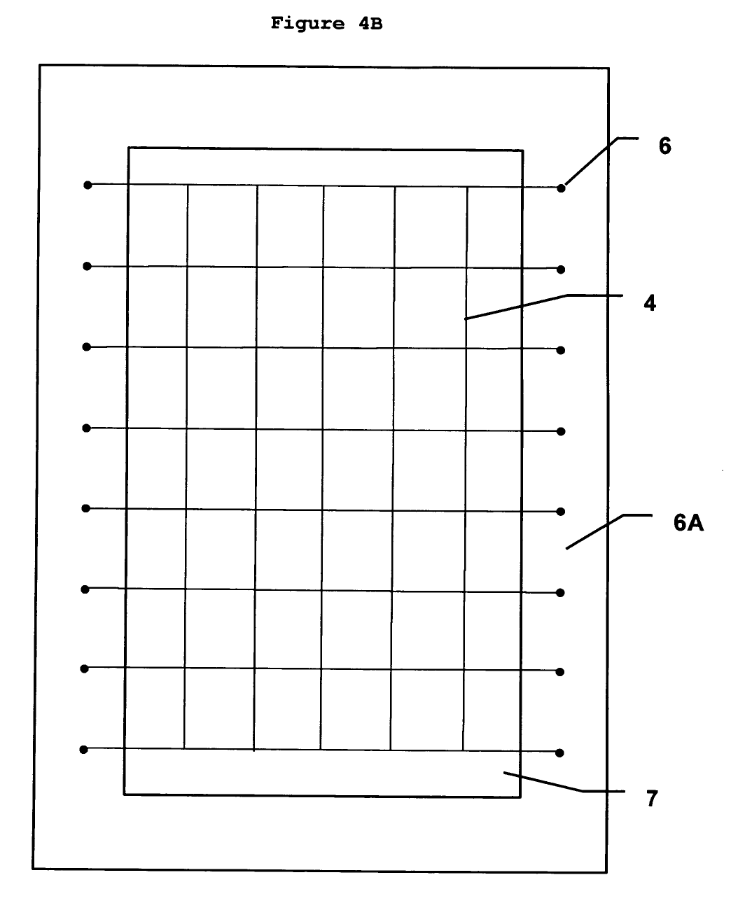

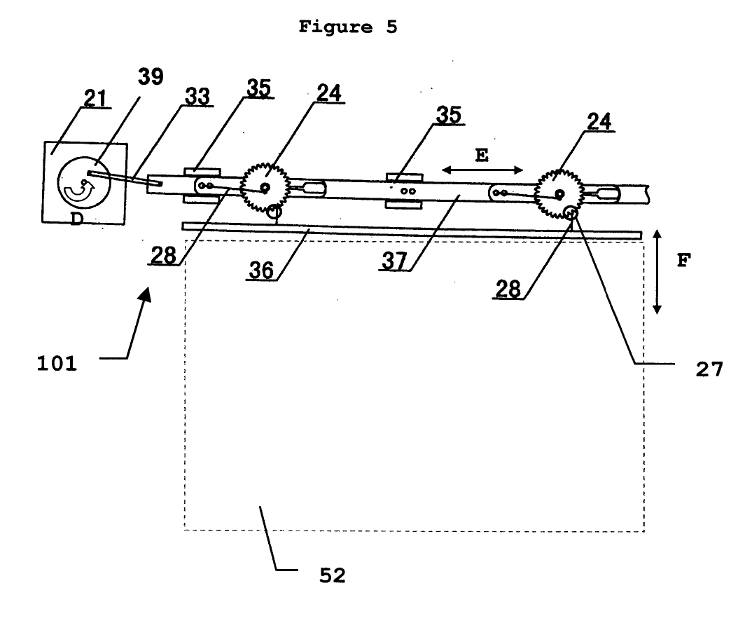

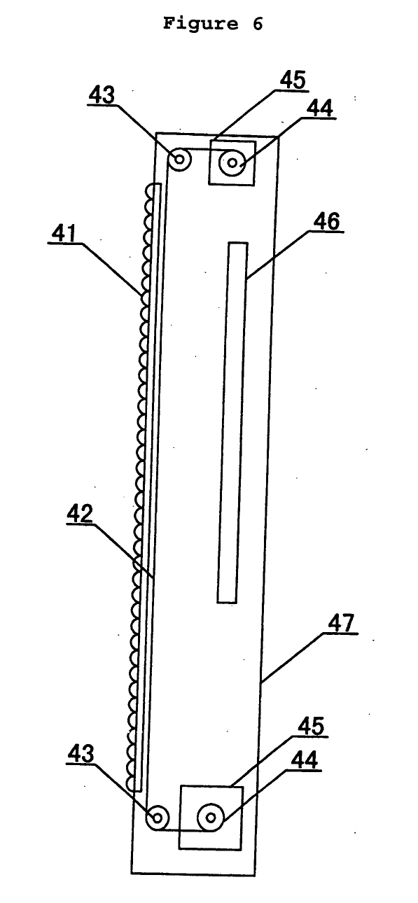

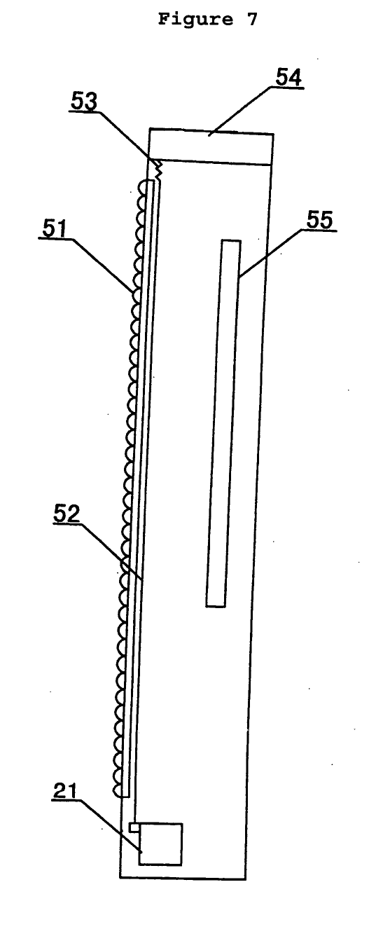

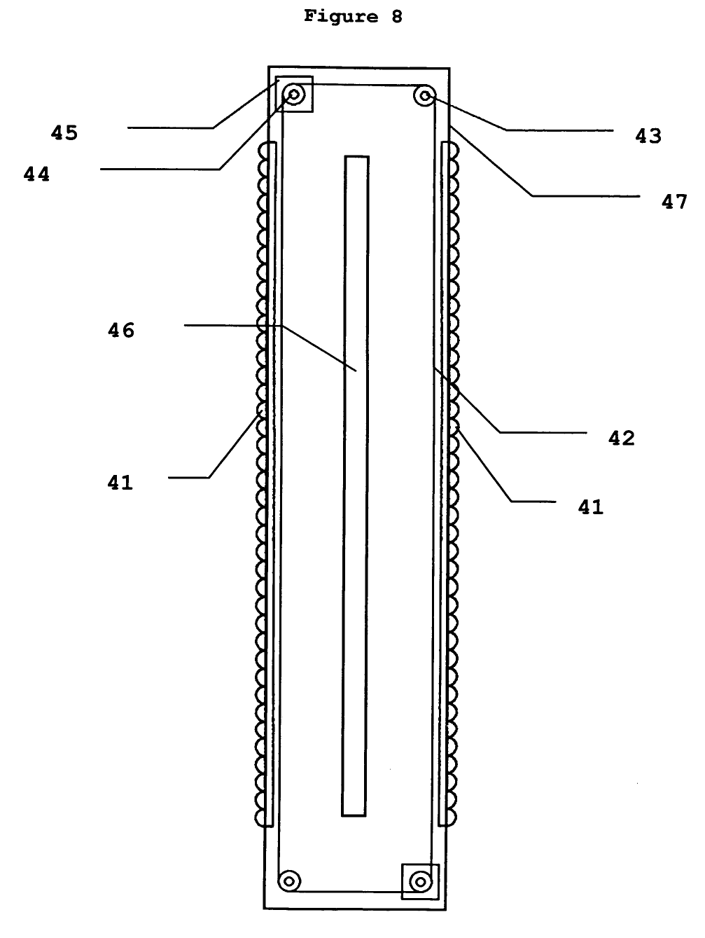

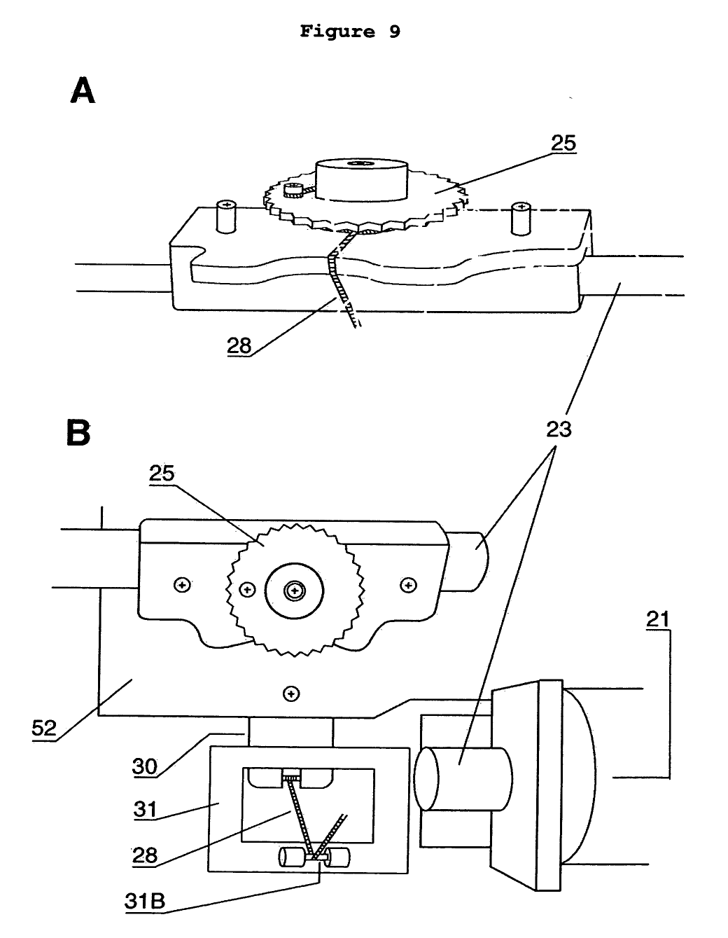

FIG. 1B is a side elevation view of an embodiment of the lenticular lens sheet 1 of the present invention. The lenticular lens sheet 1 comprises a linear array of trapezoidal cylindrical lenses 3 on one side and a linear array of corresponding convex cylindrical lenses 2 on the other side. The adjacent trapezoid-convex cylindrical lenses may spaced apart with a predetermined gap 12. For example, a lenticular lens sheet comprising trapezoid-convex cylindrical lenses which are adjacent to one another and which are not separated by any gaps is used in smaller displays where the viewing distance is shorter and the lenticules need to be closer together to form a sharper image.

When adjacent trapezoid-convex cylindrical lenses are spaced apart, the width of the gaps does not exceed ⅓ of the width of one lenticule or lens. The gaps adjacent trapezoid-convex cylindrical lenses are opaque.

FIG. 1C is a side elevation view of a preferred embodiment of the lenticular lens sheet 1 of the present invention 1. The convex cylindrical lenses have the same width R2 as the corresponding trapezoidal cylindrical lenses. The length of the short parallel side L2 of the trapezoidal cylindrical lens is preferably 0.84 mm; the length of each lens L1 is preferably 2.54 mm; the gap width L3 between each adjacent lens is preferably 1.69 mm; and the width of each lens L4 is preferably 3 mm. The ratio of the lens measurements, i.e., L1:L2:L3:L4:R2, may vary depending on the size and resolution of the lens.

FIGS. 1D and 1E shows the 3-D view of the trapezoid cylindrical lens of the lenticular lens sheet of the present invention. FIG. 1D shows a trapezoid prism. FIG. 1E shows a frustum.

FIG. 2 is a structural representation of a rotor-shaft image actuating assembly of the present invention.

FIG. 3 is a structural representation of the fine-tuning assembly of the present invention. FIGS. 3A and 3B show the components behind the image fine-tuning assembly, i.e., drawing thread 28, drawing plate 30, guiding rod 31B and drawing-plate sliding chute. The image fine-tuning assembly and the rotor-shaft image actuating assembly may be mounted above or below the lenticular image. The position and/or orientation of the image fine-tuning assembly and the rotor-shaft image actuating assembly may be readily determined by one of ordinary skill in the art based on the present disclosure.

FIG. 4A is a structural representation of an elastic close-contact net of the present invention. The net can be formed by running one or more wires from side to side in a zig-zag pattern. Other patterns, such as criss-cross, diagonal, horizontal or horizontal and/or combinations thereof, may also be used. The wire(s) may be anchored to the display using screws, rivets, clips, columns, latches or other suitable parts for securing the wire(s) to the display. The wires such as elastic metal wires or plastic strings may be used. The close-contact net maintains the lenticular image in intimate contact with the backside of the lenticular lens sheet. Preferably, the space between the lenticular image and the backside of the lenticular lens sheet is less than 3 mm.

FIG. 4B is a structural representation of an elastic close-contact net of the present invention having a square- or rectangular-shaped pattern.

FIG. 5 is a structural representation of a sliding bar image actuating assembly of the present invention.

FIG. 6 is a side view of the embodiment of Example 1.

FIG. 7 is a side view of the embodiment of Example 2.

FIG. 8 is a side view of a two-sided, scrolling lenticular image display of the present invention.

FIG. 9 is a front side view of a rotor-shaft image actuating assembly of the present invention. FIG. 9A shows the backside of an image fine-tuning assembly mounted on a rotor-shaft. FIG. 9B is a front side view of a rotor-shaft image actuating assembly with the rotor-shaft removed to show the components located on the backside. FIG. 9B shows a drawing-plate sliding chute 31 attached to the display housing and a drawing plate 30 attached to a lenticular image 52. The drawing thread 28 is fixed to the drawing plate 30 and passed through a metal guide rod 31-R on the drawing-plate sliding chute 31 and adjustably attached to the image fine-tuning assembly mounted on the rotor-shaft.

The present invention will be described in connection with preferred embodiments, however, it will be understood that this is no intent to limit the invention to the embodiments described. On the contrary, the intent is to cover all alternatives, modifications, and equivalents as may be included within the spirit and scope of the invention as defined by the appended claims.

### DETAILED DESCRIPTION OF THE INVENTION

This invention provides a self-actuating lenticular image display, comprising: a lenticular lens sheet attached to the front side of a display housing; a lenticular image; a close-contact net securely mounted behind the lenticular image to maintain the lenticular image and the lenticular lens sheet in intimate contact; and an image actuating assembly mounted inside the display housing for moving the lenticular image.

In an embodiment, the lenticular image comprises two or more frames of independent, interlaced images.

In an embodiment, the close-contact net is constructed of suitable elastic threads, and is mounted on a plurality of anchor points or columns in a zigzag or criss-cross pattern behind the lenticular image. In another embodiment the close-contact net comprises a rectangular- or square-shaped net or mesh.

In an embodiment, the image actuating assembly comprises two guide rolls; two reel spindles; two speed reduction axles; and two power-driven reduction boxes, wherein the guide rolls are rotatably mounted on the sides of the display housing; wherein one guide roll is rotatably mounted on the upper part of the display housing and the other guide roll is rotatably mounted on the lower part of the display housing; wherein the reel spindles are rotatably mounted on the sides of the display housing; wherein one reel spindle is rotatably mounted on the upper part of the display housing and the other reel spindle is rotatably mounted on the lower part of the display housing; wherein one end of the lenticular image is rolled up against one reel spindle and the other end of the lenticular image is fixably attached to the other reel spindle; wherein the reel spindles are connected to the reduction boxes by the speed reduction axles; wherein the movement of the reel spindles is controlled by the reduction boxes; and wherein the reduction boxes are driven by suitable driving means for providing movement to the lenticular image.

In an embodiment, the driving means is controlled by a microcontroller. In another embodiment, the software or program embedded in the microcontroller described above.

In an embodiment, a light source is mounted inside the display housing for illuminating the lenticular image.

In an embodiment, the guide rolls are positioned as to maintain the lenticular image in intimate contact with the backside of the lenticular lens sheet.

In an embodiment, the image actuating assembly comprises two guide rolls; a reel spindle; a spring-loaded reel spindle; a speed reduction axle and a power-driven reduction box; wherein the guide rolls are rotatably mounted on the sides of the display housing; wherein one guide roll is rotatably mounted on the upper part of the display housing and the other guide roll is rotatably mounted on the lower part of the display housing; wherein the reel spindle and the spring-loaded reel spindle are rotatably mounted on the sides of the display housing; wherein one reel spindle is rotatably mounted on the upper part of the display housing and the other reel spindle is rotatably mounted on the lower part of the display housing; wherein one end of the lenticular image is rolled up against the spring-loaded reel spindle and the other end of the lenticular image is fixably attached to the reel spindle; wherein the reel spindle is operatively connected to the reduction box by the speed reduction axle; wherein the movement of the reel spindle is controlled by the reduction boxes, and wherein the reduction box is driven by suitable driving means for providing movement to the lenticular image.

In an embodiment, the image actuating assembly comprises a driving means for providing movement to the lenticular image; a reduction box; a plurality of springs, a rotor-shaft; a rotor-shaft mount; and a image fine-tuning assembly; wherein the reduction box comprises a speed reduction axle; and wherein the image fine-tuning assembly is mounted on the rotor-shaft.

In an embodiment, the image fine-tuning assembly comprises a gear; a positioning nose spike; and a drawing thread; wherein one end of the drawing thread is attached to the gear; wherein the drawing thread forms at least one loop around the rotor-shaft or gear; and wherein the other end of the drawing thread is attached to one end of the lenticular image; wherein the other end of the lenticular image is detachably attached to the display housing via a plurality of elastic suspension means.

In an embodiment, the image actuating assembly comprises a driving means for providing movement to the lenticular image; a reduction box; an eccentric rotating disc; a sliding bar; a drag bar; a slide bar chute; and an image fine-tuning assembly; wherein the reduction box comprises a speed reduction axle; wherein the driving means is operatively connected to the reduction box; wherein the speed reduction axle of reduction box is operatively connected to the eccentric rotating disc; wherein the eccentric rotating disc is moveably connected to the sliding bar via the drag bar; wherein the sliding bar is moveably attached to the slide bar chute; and wherein the image fine-tuning assembly is mounted on the sliding bar. In another embodiment, the image fine-tuning assembly comprises a gear; a positioning nose spike; a thread-drawing pulley; a drawing thread; a bottom plate and a drawing plate; wherein one end of the drawing thread is attached to the bottom plate; wherein the other end of the drawing thread is passed through the gear and thread-drawing pulley and attached to the drawing plate; and wherein one end of the lenticular image is detachably attached to the drawing plate and the other end of the lenticular image is detachably attached to the frame of the display house via a plurality of elastic suspension means.

In an embodiment, the lenticular lens sheet comprises a linear array of trapezoid-convex cylindrical lenses, wherein the one side of the lenticular lens sheet comprises a linear array of trapezoidal cylindrical lenses, and wherein the other side of the lenticular lens sheet comprises a linear array of corresponding convex cylindrical lenses. In another embodiment, the adjacent lenses are spaced apart by a gap. In a further embodiment, the gap is opaque.

In an embodiment, the thickness of the trapezoidal cylindrical lens is the same as the thickness of the convex cylindrical lenses. In another embodiment, the short parallel sides of the trapezoidal cylindrical lens is 0.84 mm; wherein the width of each lens is 2.54 mm; wherein the gap width is 1.69 mm; and wherein the thickness of each lens is 3 mm.

This invention provides a method for eliminating or minimizing soft spots or ghosting effect on the display of claim 1, comprising: (a) providing at an image fine-tuning assembly, wherein the image fine-tuning assembly comprises a gear; a positioning nose spike; and a drawing thread; (b) providing a close-contact net for maintaining the lenticular image in intimate contact with the back side of a lenticular screen; (c) mounting the close-contact net securely behind the lenticular image; (d) mounting the image fine-tuning assembly on the image actuating assembly; and (e) adjusting the gear on the image fine-tuning assembly to adjust the length of the drawing thread to align the horizontally interlaced images of the lenticular image in parallel with the lenticular lens.

This invention provides a novel lenticular image display which does not have the drawbacks of the existing lenticular image displays, as mentioned above.

This invention provides a lenticular image display comprising of a lenticular lens sheet, a lenticular image, an image actuating assembly, an image fine-tuning assembly, and an image close-contact net.

Because of the close-contact net, the orientation of the display is not dictated by gravitational forces. The display of the present invention may be positioned upright, sideways, diagonal, slightly inclined or faced down, depending on the particular application.

The image actuating assembly, image fine-tuning assembly and the close-contact net produce image changeovers that are clear and precise; thus, allowing the display to serve as stationary, rotational or multi-directional advertising medium.

The lenticular image display of the present invention is capable of displaying a series of images, usually two or more images or frames, sequentially. The lenticular lens is designed for displaying an interlaced or composite image, one frame at a time, when the lenticular image is moved. The lenticular lens sheet of the present invention comprises a transparent, linear array of (1) plano-convex cylindrical lenses or (2) trapezoid-convex cylindrical lenses with or without a gap between adjacent lenses (see FIG. 1A-C), or (3) a barrier strip comprising alternating transparent and opaque lines. When the lenticular or interlaced image is placed against a barrier strip, only one picture at a time is shown through the transparent lines and the rest is hidden behind the opaque lines. The width of the transparent lines corresponds to the width of each independent picture in the lenticular image and can be readily determined and/or fabricated by one of ordinary skill in the art. The concept and operation of the barrier strip is described in U.S. Pat. No. 6,624,947 issued to McKinley. See, for example, FIG. 13 and FIG. 14 and column 10, lines 25-30 of U.S. Pat. No. 6,624,947.

(1) Trapezoid-Convex Cylindrical Lens Sheet of the Present Invention

The front side of trapezoid-convex cylindrical lens sheet comprises a linear array of convex cylindrical lenses, and the backside of the lens sheet comprises a linear array of corresponding trapezoidal cylindrical lenses. See FIG. 1. The trapezoidal cylindrical lenses allow the lenticular image to pass through the trapezoidal surface only, and the two bevels serve as a shield. In an embodiment, the adjacent trapezoid-convex cylindrical lenses are spaced apart with a predetermined gap. In another embodiment, the gaps between adjacent trapezoid-convex cylindrical lenses are opaque. In a further embodiment, the convex cylindrical lenses and the trapezoidal cylindrical lenses have the same width R2. In a further embodiment, the gap width L3 is less than ⅓ of the width the convex cylindrical lens or the trapezoidal cylindrical lens R2. See FIG. 1B.

In a further embodiment, the length of the short parallel side L2 of the trapezoidal cylindrical lens is 0.84 mm; the length of each lens L1 is 2.54 mm; the gap width L3 between each lens is 1.69 mm; and the width of each lens L4 is 3 mm. See FIG. 1C.

In a further embodiment, the ratio of the lens measurements, i.e., L1:L2:L3:L4:R1, may vary depending on the size of the lens.

In a further embodiment, the trapezoidal cylindrical lens has the shape of a trapezoid prism or a frustum, as shown in FIGS. 1D and 1E, respectively.

The trapezoidal cylindrical lenses greatly reduce “ghosting” effect or “soft spots” when the lenticular image is shown through the lenticular lens sheet.

The trapezoid-convex cylindrical lens of the present invention combines the optical advantages and key benefits of both plano-convex cylindrical lens and the barrier strip. When a lenticular image is shown through a lenticular lens sheet with plano-convex cylindrical lenses, a person who is observing the lenticular image display from an angle might not perceive an image that is as clear and sharp as a person who is standing directly in front of the lenticular image display. Also, a person who stands too close to a barrier strip will be able to discern the individuals alternating opaque and transparent strips, thereby distorting the displayed image. The trapezoid-convex cylindrical lens of the present invention allows the lenticular image to be clearly viewed from a wider angle as well as at a closer distance.

An elastic close-contact net or mesh, i.e., see FIGS. 4A and 4B, as described above may be mounted or arranged on the backside of the lenticular image so that it is held tightly against the lenticular lens and maintains the required intimate contact between the two.

(2) Lenticular Images

The lenticular images that are typically used with the lenticular lens sheets are images comprising of several independent images interlaced into a space the size of one lenticule. The number of independent images which can be interlaced within a space the size of one lenticule can be readily determined by one of ordinary skill in the art. Preferably, two or more independent images are interlaced together in series to form one lenticular image.

Each lenticular image or lenticular scrolls may be readily generated or produced by a computer program or system designed for such purpose by one of ordinary skill in the art. See U.S. Pat. Nos. 5,364,274 and 5,494,445 for a discussion on the process of making a lenticular image.

(3) Elastic Image Close-Contact Net

Mounted on the interior of the display are staggered anchor points or columns for anchoring one or more wires, fibers or threads to form a close-contact net for maintaining intimate contact of the lenticular lens sheet with the lenticular image. See FIG. 4A. The anchor points or columns may also be mounted directly opposite one another. See FIG. 4B.

To form a close-contact net, one or more elastic fibers or threads, such as metal wires, chemical fibers or natural fibers, are run from an anchor point on one side to another anchor point on the opposite side in a zig-zag pattern. Parallel, crossover or cornerwise wrapping patterns may also be used to create the close-contact net. The threads or fibers should be strong enough to maintain the lenticular image in intimate contact with the backside of the lenticular lens sheet for an extended period of time, elastic enough to permit fast changing of the lenticular image without breaking, and thin enough or transparent so that it is not visible through the display.

(4) Image Actuating Assembly and Image Fine-Tuning Assembly

4.1 Rotor-Shaft Image Actuating Assembly and Image Fine-Tuning Assembly

The rotor-shaft image actuating assembly of the present invention, generally depicted by numeral 100, comprises a stepping motor 21, a reduction box 22, a rotor-shaft 23, a rotor-shaft mount 23A, a plurality of springs and an image fine-tuning assembly, generally depicted by numeral 24. The stepping motor 21 is operatively connected to the reduction box 22, and the speed reduction axle of reduction box 22 is operatively connected to the rotor-shaft 23. An image fine-tuning assembly 24 may be mounted on the rotor-shaft 23. See FIG. 2.

The image fine-tuning assembly 24 comprises a torque gear 25, a positioning nose spike 26, a thread-drawing pulley 27, a drawing thread 28, a thread-drawing column 29, a drawing plate 30 and a drawing-plate sliding chute 31. See FIG. 3. The drawing-plate sliding chute 31 is attached to the display housing. In an embodiment, the image fine-tuning assembly comprises a torque gear, a positioning nose spike and a drawing thread.

The lenticular image 52 is mounted on the image actuating assembly 100. One end of the lenticular image 52 is movably connected to a plurality of springs which are attached to one end of the display housing. One end of the drawing thread 28 is attached to the other end of the lenticular image 52. The other end of the drawing thread 28 makes at least one loop around the torque gear, and is attached to an image fine-tuning assembly. The image fine-tuning assembly 24 is mounted on the rotor-shaft 23. The rotor-shaft 23 is rotatably mounted on the other end of the display housing, and rotates around its horizontal axis by means of a motor 21 and reduction box 22. Fine-tuning of the alignment of the lenticular image 52 to the lens can be accomplished by adjusting the tension on the drawing thread 28 using the torque gear 25. See FIG. 2. In an embodiment, the drawing thread may be attached to the lenticular image by means of a drawing plate 30, and the sliding movement of the drawing plate 30 is guided by the drawing-plate sliding chute 31. The drawing-plate sliding chute 31 is mounted on the interior of the display housing. The drawing thread may be attached to lenticular image by other suitable means, such as a buckle, clip, Velcro, or reclosable fasteners.

Once the alignment of the lenticular image 52 is complete, the operation of the rotor-shaft image actuating assembly 100 mounted within the lenticular image display of the present invention is as follows:

(a) The motor 21 starts up and rotates the rotor-shaft 23 in a intermittent clockwise and counter-clockwise motion, as depicted by arrows A and B.

(b) The rotation of the rotor-shaft 23 in one direction retracts the drawing thread 28 which pulls the lenticular image 52 toward the rotor-shaft 23; thereby, creating additional tension against the springs. The rotation of the rotor-shaft 23 in the other direction releases the drawing thread 28, and allows image to move away from the rotor-shaft 23. The movement of the lenticular image is depicted by arrow C.

The lenticular image can be prepared by using currently available computer software to interlace two or more independent images to form one composite image. It is then printed on an appropriate medium at the appropriate size, which corresponds to the overall size of the lenticular display and the number of lenticules on the particular lenticular screen being used.

When the interlaced image moves perpendicularly against the lenticular lens sheet by means of the image actuating assembly, for a predetermined amount of time, composite image will be shown, one frame at a time, through the lens; thereby creating the illusion of one image fading into another.

If the stepping motor carries out counter- or contra-rotation, then different lenticular images on the lenticular image scroll will be shown or displayed in the reverse order.

4.2 Sliding Bar Image Actuating Assembly and Image Fine-Tuning Assembly

The sliding bar image actuating assembly, generally depicted as numeral 101, comprises a stepping motor 21, a reduction box, an eccentric rotating disc 39, a sliding bar 37, a drag bar 33, a plurality of springs and a slide bar chute 35. An image fine-tuning assembly 24 is mounted on the slide bar 37. The fine-tuning assembly comprises a torque gear 25, a positioning nose spike 26, a thread-drawing pulley 27, a drawing thread 28 and a drawing plate 36. The stepping motor 21 is operatively connected to the reduction box, and the speed reduction axle of the reduction box is operatively connected to the eccentric rotating disc 39. The eccentric rotating disc 39 is operatively connected to the sliding bar 37 by a drag bar 33, and the sliding bar 37 is moveably mounted on the slide bar chute 35. See FIG. 5.

The operation of the sliding bar image actuating assembly is as follows:

(a) The motor 21 starts up and drives the reduction box. The speed reduction axle of reduction box rotates the eccentric rotating disc 39.

(b) The rotation of the eccentric rotating disc 39, generally depicted as arrow D, causes the drag bar 33 and the sliding bar 37 to move horizontally, as depicted by arrow E, which pull and release the drawing thread 28 of the fine-tuning assembly 24 against the thread-drawing pulley. The pulling and release of the drawing thread 28 causes the drawing plate 36 to move in the direction, as depicted by arrow F, which results in the steady and controlled changeover of the lenticular images 52. See FIG. 5.

4.3 Reel Spindle Assembly

The reel spindle assembly comprises two guide rolls 43, two reel spindles 44, and two power-driven reduction boxes 45. The two reel spindles 44 are mounted on the speed reduction axle of the power-driven reduction box 45. One end of the lenticular image 42 is attached to one reel spindle. The lenticular image 42 passes through two guide rolls 43, which are mounted on the display housing and positioned as to allow the lenticular image 42 to cling tightly onto the backside of the lenticular lens sheet 41. The other end of the lenticular image 42 is then rolled up against the other reel spindle 44.

A light source 46 may be mounted behind the lenticular image 42 to provide illumination. The power-driven reduction box 45 may be driven by a stepping motor. The stepping motor may also be adapted to control the rotation of reel spindle 44 automatically.

The operation of the reel spindle assembly is as follows:

(a) Multiple sets of lenticular images are pre-printed on a long scroll of appropriate material. One end of the scroll is fixed on one reel spindle, and the other end of the scroll is rollup against the other reel spindle.

(b) Two power-driven reduction boxes simultaneously or sequentially control the rotation of the two reel spindles and the movement of the lenticular images. Each set of lenticular image is displayed for a pre-determined period of time to cycle through the individual interlaced images contained within a particular set of lenticular image. When one reel spindle has unrolled the entire scroll, the power-driven reduction boxes will reverse direction and display each set of lenticular image in the reverse order.

The power-driven reduction boxes 45 (i) control the rotation of the reel spindle 44 and the movement of the each set of lenticular image; (ii) control the duration that each set of lenticular images is displayed; and (iii) control the duration that each frame of the lenticular image is displayed.

This invention provides a two-sided lenticular image display comprising the reel spindle assembly of the present invention. In an embodiment, the two-sided lenticular image display which comprises the reel spindle assembly as shown in FIG. 8. Multiple sets of lenticular images may be pre-printed on a long scroll of appropriate material. The scroll forms a closed loop, and different sets of lenticular images are displayed continuously by the lenticular image display.

In another embodiment, the reel spindle assembly comprises two guide rolls 43, a reel spindle 44, a power-driven reduction box 45, and a spring-loaded reel spindle. The lenticular image is rolled onto the spring-loaded reel spindle.

The operation of the above-described reel spindle assembly is as follows:

(a) A scroll containing multiple sets of lenticular images is rolled up against the spring-loaded reel spindle.

(b) The power-driven reduction box 45 rotates the reel spindle 44 which causes the scroll to roll up against the reel spindle 44 until the entire scroll has been unrolled from the spring-loaded reel spindle. The power-driven reduction box 45 then rotates the reel spindle 44 in the reverse direction, and the different sets of lenticular image are displayed in the reverse order. The force of the spring mounted within the spring-loaded reel spindle allows the lenticular image to be fully stretched and maintain intimate contact with the backside of the lenticular lens sheet.

Other advantages and aspects of the present invention will become apparent upon reading the following examples.

### EXEMPLIFICATION

The invention being generally described, will be more readily understood by reference to the following examples which are included merely for purposes of illustration of certain aspects and embodiments of the present invention, and are not intended to limit the invention.

### Example 1

### Reel Spindle Assembly

A lenticular lens sheet is mounted on the front part of a display housing 47. A reel spindle assembly is mounted inside the display housing 47. The reel spindle assembly comprises two guide rolls 43, two reel spindles 44, and two power-driven reduction boxes 45. The speed reduction axle of the power-driven reduction box 45 is operatively connected to the reel spindle 44, and the power-driven reduction box 45 can automatically control the rotation of reel spindle 44. The power-driven reduction box may be driven by a stepping motor or other suitable driving means, such as a magnetic micro-motor.

One end of the lenticular image 42 is rollup against one of the reel spindles 44. The other end of the lenticular image 42 is passed over the two guide rolls 43, and is attached to the other reel spindle 44, which is connected to the speed reduction axle of the other power-driven reduction box 45. The guide rolls are positioned as to maintain the lenticular image 42 in intimate contact with the backside of the lenticular lens sheet 41.

A light source, such as fluorescent tube fixtures, incandescent light fixtures, light-emitting diodes (LED), organic light-emitting diodes (OLED), halogens, or fluorescent lamps, lasers, or other luminescent materials, is optionally mounted behind the lenticular image 42. The type of light source and/or the amount of illumination required may be readily determined by one of ordinary skill in the art.

An elastic image close-contact net or mesh, i.e., see FIGS. 4A and 4B, as described above may be mounted or arranged on the backside of the lenticular image so as to hold it tightly against the lenticular lens sheet and to maintain the required intimate contact between the two.

The appropriate size or thickness, material of construction, such as wood, plastic, composite materials or metal, and/or shape of the display housing of the lenticular image display may be readily determined and/or fabricated by one of ordinary skill in the art. The appropriate types of motors or driving means, other than motors or stepping motors, for rotating, actuating or moving the lenticular images can also be readily determined and selected by one of ordinary skill in the art without undue experimentation.

### Example 2

### Lenticular Image Display with Lenticular Lens Sheet, Rotor-Shaft Image Actuating Assembly and Image Fine-Tuning Assembly

A lenticular lens sheet 51 is mounted on the front part of display housing 54, as shown in FIG. 7. A rotor-shaft image actuating assembly and image fine-tuning assembly are mounted inside the display housing 54. The components of the rotor-shaft image actuating assembly and image fine-tuning assembly are shown in FIGS. 2 and 3. The rotor-shaft image actuating assembly comprises a stepping motor 21, a reduction box 22, a rotor-shaft 23, a plurality of springs, a rotator-shaft mount 23A, and an image fine-tuning assembly 24. The stepping motor 21 is operatively connected to the reduction box 22. The speed reduction axle of reduction box 22 is operatively connected to the rotor-shaft 23. A fine-tuning assembly is mounted on the rotor-shaft.

The fine-tuning assembly 24 comprises a torque gear 25, a positioning nose spike 26, a thread-drawing pulley 27, a drawing thread 28, a thread-drawing column 29, a drawing plate 30, and a drawing-plate sliding chute 31. In an embodiment, the fine-tuning assembly comprises a torque gear, a positioning nose spike, and a drawing thread.

The lenticular image 52 is mounted on the image actuating assembly 100. One end of the lenticular image 52 is movably connected to a plurality of springs which are attached to one end of the display housing. One end of the drawing thread 28 is attached to the other end of the lenticular image 52. The other end of the drawing thread 28 makes at least one loop around the torque gear or rotor-shaft, and is attached to an image fine-tuning assembly. The fine-tuning assembly 24 is mounted on the rotor-shaft 23. The rotor-shaft 23 is rotatably mounted on the other end of the display housing, and rotates around its horizontal axis by means of a motor 21 and reduction box 22. Fine-tuning of the alignment of the lenticular image 52 to the lens can be accomplished by adjusting the tension on the drawing thread 28 using the torque gear 25. See FIG. 2.

Elastomeric materials or elastic suspension means, such as rubber bands may also be used to attach the lenticular image to the display housing. See FIG. 7. As used herein, “Elastic” means that something can be deformed and it returns to its original shape.

Anchor points or columns 6 designed for holding or fastening the threads or wires 4 to form a close-contact net are arranged preferably in a zig-zag pattern or in the form of a mesh to hold the lenticular image in intimate contact with the lenticular lens sheet. See FIGS. 4A and 4B. The material of construction and the arrangement of the wires or thread may be readily determined by one of ordinary skill in the art without undue experimentation.

Alternatively, the anchor points or columns 6 which are positioned around the borders of the lenticular image. See FIG. 4A. A net or mesh may be formed by weaving a wire or thread 4, such as an elastic fiber thread, from a anchor point or column mounted on one side to another column mounted on the opposite side. See FIG. 4A. The lenticular image is inserted between close-contact net and the lenticular lens sheet.

An elastic image close-contact net or mesh, i.e., see FIGS. 4A and 4B, as described above may be mounted or arranged on the backside of the lenticular image so as to hold the lenticular image tightly against the lenticular lens sheet and to maintain the required intimate contact between the two.

A light source, such as fluorescent tube fixtures, incandescent light fixtures, light-emitting diode (LED), organic light-emitting diode (OLED), halogen, or fluorescent lamp, laser, or other luminescent material, is mounted behind the lenticular image. The type of light source and the amount of illumination required may be readily determined by one of ordinary skill in the art.

The appropriate size or thickness, material of construction, such as wood, plastic, composite materials or metal, and/or shape of the display housing of the lenticular image display may be readily determined and/or fabricated by one of ordinary skill in the art. The appropriate types of motors or driving means, other than motors or stepping motors, for rotating, actuating or moving the lenticular images can also be readily determined and selected by one of ordinary skill in the art without undue experimentation.

### Example 3

### Lenticular Lens Sheet with a Linear Array of Trapezoid-Convex Cylindrical Lenses, and Sliding Bar Image Actuating Assembly

A lenticular lens sheet comprising a linear array of trapezoid-convex cylindrical lenses is mounted on the front part of the display housing. The components of the trapezoid-convex cylindrical lenses 1 are shown on FIG. 1A-1E.

This invention provides a lenticular lens sheet comprising a linear array of trapezoidal cylindrical lenses on one side and a linear array of corresponding convex cylindrical lenses on the other side.

In an embodiment, each adjacent lens is separated by a gap. In another embodiment, the gap is opaque. The width of the gap L3 is less than ⅓ of the width R2 of the convex cylindrical lens or trapezoidal cylindrical lens. Preferably the gap width L3 is 1.69 mm. See FIG. 1C. In another embodiment, the convex cylindrical lens has the same width as the trapezoidal cylindrical lens. In a preferred embodiment, the length of the short parallel side L2 of the trapezoidal cylindrical lens is 0.84 mm; the length of each lens L1 is 2.54 mm; the gap width L3 between each lens 1.69 mm; and the width of each lens L4 is 3 mm. See FIG. 1C.

In a further embodiment, trapezoidal cylindrical lenses have the shape of a trapezoid prism or frustum. Lenses having other geometric shapes may also be used to construct the trapezoidal cylindrical lenses of the lenticular lens sheet the present invention.

A sliding bar image actuating assembly and an image fine-tuning assembly are mounted inside the display housing. An embodiment of the sliding bar image actuating assembly and fine-tuning assembly of the present invention is shown in FIG. 5 and FIG. 3, respectively. The sliding bar image actuating assembly comprises a stepping motor 21, a reduction box, a drag bar 33, an eccentric rotating disc 39, a sliding bar 37, a plurality of springs, rollers 29 and a slide bar chute 35. At least one fine-tuning assembly is mounted on the sliding bar 37. The fine-tuning assembly 24 comprises a torque gear 25, a positioning nose spike 26, a thread-drawing pulley 27, a drawing thread 28, and a drawing plate 36.

The stepping motor 21 or other suitable driving means is operatively connected to the reduction box. The speed reduction axle of reduction box is operatively connected to the eccentric rotating disc 39, and the eccentric rotating disc 39 is moveably connected to the sliding bar 37 by the drag bar 33. The sliding bar 37 is moveably attached to the slide bar chute 35.

One end of drawing thread 28 is attached to the bottom plate 32 of the image fine-tuning assembly 24. The other end of drawing thread 28 is passed through the torque gear 25 and thread-drawing pulley 27, and is attached to the drawing plate 36. The drawing plate 36 is connected to one end of the lenticular image, and the other end of the lenticular image is connected to the frame of the display housing by one or more springs, elastomeric materials or elastic suspension means, such as rubber bands. The torque gear 25 is designed for precisely adjusting the length of drawing thread 28 so that the lenticular image is maintained in parallel with the lenticular lens 3.

When the sliding bar moves horizontally toward the reduction box, the fine-tuning assembly pulls the drawing thread against the thread-drawing pulley which pulls the drawing plate and the lenticular image toward the sliding bar. In reverse, when the sliding bar moves horizontally away from the reduction box, the tension of the drawing thread is released and the lenticular image will slowly move away from the sliding bar.

A light source, such as fluorescent tube fixtures, incandescent light fixtures, light-emitting diode (LED), organic light-emitting diode (OLED), halogen, or fluorescent lamp, laser, or other luminescent material, is mounted behind the lenticular image. The type of light source and the amount of illumination required may be readily determined by one of ordinary skill in the art.

An elastic image close-contact net or mesh, i.e., see FIGS. 4A and 4B, as described above may be mounted or arranged on the backside of the lenticular image so as to hold the lenticular image tightly against the lenticular lens sheet and to maintain the required intimate contact between the two.

The appropriate size, material and/or shape of the external housing or enclosure of the lenticular image display unit may be readily determined and/or fabricated by one of ordinary skill in the art. The appropriate types of motors or driving means, other than motors or stepping motors, for rotating or moving the lenticular images can also be readily determined by one of ordinary skill in the art.

The appropriate size or thickness, material of construction, such as wood, plastic, composite materials or metal, and/or shape of the display housing of the lenticular image display may be readily determined and/or fabricated by one of ordinary skill in the art. The appropriate types of motors or driving means, other than motors or stepping motors, for rotating, actuating or moving the lenticular images can also be readily determined and selected by one of ordinary skill in the art without undue experimentation.

### EQUIVALENTS

Those skilled in the art will recognize, or be able to ascertain using no more than routine experimentation, many equivalents to the specific embodiments of the invention described herein. Such equivalents are intended to be encompassed by the following claims.

1. A self-actuating lenticular image display, comprising:
a lenticular lens sheet attached to the front side of a display housing;
a lenticular image;
a close-contact net securely mounted behind the lenticular image to maintain the lenticular image and the lenticular lens sheet in intimate contact; and
an image actuating assembly mounted inside the display housing for moving the lenticular image.

2. (canceled)

3. The display of claim 1, wherein the close-contact net is constructed of suitable elastic threads, and is mounted on a plurality of anchor points or columns in a zigzag or criss-cross pattern behind the lenticular image.

4. The display of claim 1, wherein the close-contact net comprises a rectangular- or square-shaped net or mesh.

5. The display of claim 1, wherein the image actuating assembly comprises two guide rolls; two reel spindles; two speed reduction axles; and two power-driven reduction boxes,
wherein the guide rolls are rotatably mounted on the sides of the display housing; wherein one guide roll is rotatably mounted on the upper part of the display housing and the other guide roll is rotatably mounted on the lower part of the display housing;
wherein the reel spindles are rotatably mounted on the sides of the display housing; wherein one reel spindle is rotatably mounted on the upper part of the display housing and the other reel spindle is rotatably mounted on the lower part of the display housing;
wherein one end of the lenticular image is rolled up against one reel spindle and the other end of the lenticular image is fixably attached to the other reel spindle;
wherein the reel spindles are connected to the reduction boxes by the speed reduction axles; wherein the movement of the reel spindles is controlled by the reduction boxes; and
wherein the reduction boxes are driven by suitable driving means for providing movement to the lenticular image.

6-7. (canceled)

8. The display of claim 1, further comprising a light source mounted inside the display housing for illuminating the lenticular image.

9. (canceled)

10. The display of claim 5, wherein the guide rolls are positioned as to maintain the lenticular image in intimate contact with the backside of the lenticular lens sheet.

11-15. (canceled)

16. The display of claim 1, wherein the image actuating assembly comprises a driving means for providing movement to the lenticular image; a reduction box; a plurality of springs, a rotor-shaft; a rotor-shaft mount; and a image fine-tuning assembly;
wherein the reduction box comprises a speed reduction axle; and
wherein the image fine-tuning assembly is mounted on the rotor-shaft.

17. The display of claim 16, wherein image fine-tuning assembly comprises a gear; a positioning nose spike; and a drawing thread;
wherein one end of the drawing thread is attached to the gear;
wherein the drawing thread forms at least one loop around the rotor-shaft; and wherein the other end of the drawing thread is attached to one end of the lenticular image;
wherein the other end of the lenticular image is detachably attached to the display housing via a plurality of elastic suspension means.

18-19. (canceled)

20. The display of claim 16, further comprising a light source mounted inside the display housing for illuminating the lenticular image.

21. The display of claim 17, further comprising a light source mounted inside the display housing for illuminating the lenticular image.

22. The display of claim 1, wherein the image actuating assembly comprises a driving means for providing movement to the lenticular image; a reduction box; an eccentric rotating disc; a sliding bar; a drag bar; a slide bar chute; and an image fine-tuning assembly;
wherein the reduction box comprises a speed reduction axle; wherein the driving means is operatively connected to the reduction box; wherein the speed reduction axle of reduction box is operatively connected to the eccentric rotating disc; wherein the eccentric rotating disc is moveably connected to the sliding bar via the drag bar; wherein the sliding bar is moveably attached to the slide bar chute; and wherein the image fine-tuning assembly is mounted on the sliding bar.

23. The display of claim 22, wherein the image fine-tuning assembly comprises a gear; a positioning nose spike; a thread-drawing pulley; a drawing thread; a bottom plate and a drawing plate;
wherein one end of the drawing thread is attached to the bottom plate;
wherein the other end of the drawing thread is passed through the gear and thread-drawing pulley and attached to the drawing plate; and
wherein one end of the lenticular image is detachably attached to the drawing plate and the other end of the lenticular image is detachably attached to the frame of the display house via a plurality of elastic suspension means.

24-25. (canceled)

26. The display of claim 22, further comprising a light source mounted inside the display housing for illuminating the lenticular image.

27. (canceled)

28. The display of claim 1, wherein the lenticular lens sheet comprises a linear array of trapezoid-convex cylindrical lenses, wherein the one side of the lenticular lens sheet comprises a linear array of trapezoidal cylindrical lenses, and wherein the other side of the lenticular lens sheet comprises a linear array of corresponding convex cylindrical lenses.

29-34. (canceled)

35. The display of claim 28, wherein is the adjacent lenses are spaced apart by a gap.

36. (canceled)

37. The display of claim 35, wherein the thickness of the trapezoidal cylindrical lens is the same as the thickness of the convex cylindrical lenses.

38. The display of claim 35, wherein the short parallel sides of the trapezoidal cylindrical lens is 0.84 mm; wherein the width of each lens is 2.54 mm; wherein the gap width is 1.69 mm; and wherein the thickness of each lens is 3 mm.

39-62. (canceled)

63. A method for eliminating or minimizing soft spots or ghosting effect on the display of claim 1, comprising:
(a) providing at an image fine-tuning assembly, wherein the image fine-tuning assembly comprises a gear; a positioning nose spike; and a drawing thread;
(b) providing a close-contact net for maintaining the lenticular image in intimate contact with the back side of a lenticular screen;
(c) mounting the close-contact net securely behind the lenticular image;
(d) mounting the image fine-tuning assembly on the image actuating assembly; and
(e) adjusting the gear on the image fine-tuning assembly to adjust the length of the drawing thread to align the horizontally interlaced images of the lenticular image in parallel with the lenticular lens.

64. A close-contact net for maintaining intimate contact between a lenticular sheet and a lenticular image comprising one or more suitable elastic threads mounted on a plurality of anchor points or columns in a zigzag or criss-cross or square pattern behind the lenticular image.

65. A lenticular lens sheet comprises a linear array of trapezoid-convex cylindrical lenses, wherein the one side of the lenticular lens sheet comprises a linear array of trapezoidal cylindrical lenses, and wherein the other side of the lenticular lens sheet comprises a linear array of corresponding convex cylindrical lenses.
